(19) United States
(12) Patent Application Publication
(10) Pub. No.: US 2009/0134877 A1
(43) Pub. Date: May 28, 2009

(54) Optimum signal for sea bed logging

(76) Inventor: Tor Schaug-Pettersen, Trondheim (NO)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/883,498

(22) PCT Filed: Jan. 27, 2006
(86) PCT No.: PCT/GB2006/000282

§ 371 Date: May 14, 2008

(30) Foreign Application Priority Data
Feb. 1, 2005 (GB) 0502064.9

(51) Int. Cl. G01V 3/12

(52) U.S. Cl. 324/332

(57) ABSTRACT

Multifrequency electromagnetic signals which may be used in the field of sea bed logging, the signal being optimised for use at a particular site, in order to greatly improve data inversion, and a method for producing the optimum multifrequency signal.

Many logging processes use electromagnetic signals to transmit or obtain information. One example of this is the use of electromagnetic waves in sea bed logging, a special application of controlled source electromagnetic sounding developed by ElectroMagnetic GeoServices of Norway.

In one application of this process, an electromagnetic wave field response can be used to determine the presence and/or nature of a reservoir containing hydrocarbons or water, as described in European Patent No. 1256019.

In electromagnetic sea bed logging, a number of types of transmitter signal shapes have been employed, including sinusoidal and square wave. Inversion of the logged data and the production of images from logged data can be considerably improved by logging at several different frequencies. However, if sinusoidal signals are used, logging at x frequencies will take x times as long as logging with a single signal type. In order to improve data inversion without substantially increasing logging times, multifrequency signals containing particular desired frequencies can be used.

The present invention relates to an optimised multifrequency electromagnetic signal which substantially improves inversion of logged data, and a method of obtaining such an optimised signal by selecting the parameters controlling the signal generation.

Candidate multifrequency signal types include square waves, which contain all odd multiples of the fundamental frequency. However, for square waves the amplitude of the nth harmonic frequency is proportional to n⁻¹, whereas the attenuation along a particular path is typically proportional to n^{1/2}. The signal/noise ratio at the receiver for higher harmonic frequencies is therefore relatively low, resulting in lowered quality of results from the inversion of logged data.

Alternatively, a periodic sequence of short pulses of antenna current may be used to produce the signal, providing harmonics in the transmitted signal up to approximately 1/pulse width, each harmonic frequency being of equal amplitude. However, the input to the antenna is usually current limited to a particular value, Iₘₐₓ, resulting in low power in the harmonics of such a signal.

Signal generating parameters required for the production of an electromagnetic signal comprising two or three desired frequencies of high and equal amplitudes, of use within the field of sea bed logging, are known. However, as described above, the degree of attenuation of the signal between transmitter and receiver is frequency dependent, resulting in low signal/noise ratios at the receiver for some parts of the signal. Further, in the examples known, the absolute value of the transmitting antenna current takes values substantially less than I_{M} for a substantial part of the time, with the result that both the total transmitted power and the power converted to the desired set of frequencies is less than what could be obtained from an optimal signal.

In order to improve the signal range and the inversion of logged data it is now proposed that for an optimised signal, the power transmitted at certain desired harmonic frequencies should be such that the amplitude ratios of the desired frequencies are substantially equal when the receiver is at maximum range. It is also desirable to maximise the overall signal/noise ratio at the receiver in order to improve the quality of the logged data at any given range. Therefore, an optimised signal in the context of the present invention, which may be used in the field of sea bed logging, is one for which the amplitude ratios of the desired frequencies are substantially equal at the receiver when the receiver is at maximum range, the total power delivered to the transmitting antenna is maximised, and the proportion of that power which goes into the desired frequencies is maximised.

According to the present invention, there is provided an optimised multifrequency electromagnetic signal transmitted by an antenna, the signal comprising two or more desired harmonic frequencies of optimised amplitude ratios such that substantially equal amplitude ratios of each frequency are received when the receiver is at maximum range, the total power in the desired harmonic frequencies being the maximised proportion of the maximised power deliverable to the transmitting antenna.

Optionally, the present invention may be characterised in that the antenna current takes on the values ±Iₘₐₓ only, to maximise the total power delivered to the transmitting antenna. This results in a longer signal range.

Optionally, the present invention may be further characterised in that the two or more desired frequencies are all harmonics of one frequency, and that the signal is periodic in time with the period of the fundamental, to simplify signal synthesis.

Optionally, the present invention may be further characterised in that when the transmitting antenna is capable of radiating a circularly polarised rotating field the desired harmonic frequencies are all odd harmonics, to ensure that the polarisation of each desired harmonic frequency rotates.

Optionally, the present invention may be further characterised in that the signal comprises three or more desired harmonic frequencies of optimised amplitude ratios.

According to another aspect of the present invention, there is provided a method of producing an optimised multifrequency electromagnetic signal, the method comprising obtaining optimised signal generating parameters using a transmitter-receiver offset length and modelled signal behaviour to determine a set of desired harmonic frequencies optimally suited for logging at a site, and suitable amplitude ratios for the desired harmonic frequencies: and using a transmitter to produce a signal according to the optimised signal generating parameters.

The signal generating parameters may comprise current direction switch times, signal period and number of current direction switch times per period. The parameter values may be obtained by iterative refinement of an initial standard parameter set, by comparison of the signal which would be produced by an antenna operated under those parameters with the ideal optimised signal. The choice of initial standard parameters depends on the nature of the site and required signal and in particular cases different choices may have to be tried before obtaining a covered solution set of parameters.

This method may incorporate a two step process, in which the first step comprises choosing an initial set of switching times and other parameters, perturbing the switching times and then adjusting the switching times iteratively to obtain a trial signal having substantially optimal amplitude ratios of the desired frequencies, and the second step comprises increasing the total signal power to obtain a trial signal having the maximum possible amplitude for the highest desired frequency, within the operating limits of the transmitting system, while maintaining the amplitude ratios of the desired frequencies by adjustment of signal generating parameters.

Optionally, the method of the present invention may further comprise modelling the site to be investigated through sea bed logging using some or all of the known site parameters and combining the information with the transmitter-receiver offset length and modelled signal behaviour to determine a set of desired signal frequencies optimally suited for logging at the site, and ideal amplitude ratios for the desired harmonic frequencies.

The present invention also extends to the use of an optimised or substantially optimised multifrequency electromagnetic signal for the purpose of obtaining data by the method of sea bed logging, in order to determine the presence and/or nature of a reservoir containing hydrocarbons or water.

The present invention also extends to data and results obtained from the use of an optimised multifrequency electromagnetic signal for the method of sea bed logging.

It may be desirable to apply signals with these characteristics, obtained using the optimisation method described, within other fields not related to marine controlled source electromagnetic sounding.

The method for obtaining optimal signal generating parameters is now described, and an example given. The antenna current function I(t) shall have the properties

I(t+T)=I(t), |I(t)|=Iₘₐₓ, I(t)real (1.1)

where Iₘₐₓ is the maximum value of the current. We divide the interval 0≦t≦2π into 2N parts by the points tₘ, m=1,2, . . . , 2N−1, and define

$$I ( t ) = {\sum }_{m = 1}^{2 N} {I}_{m} ( t ) , {I}_{m} ( t ) = \{ \begin{matrix}{( - 1 )}^{m - 1} \cdot {I}_{max} for {t}_{m - 1} < t < {t}_{m} \\ 0 else\end{matrix} \\ {t}_{0} = 0 , {t}_{m + 2 N} = {t}_{m} + T , {t}_{m - 1} \leq {t}_{m} \qquad ( 1.2 )$$

Symmetry considerations show that we may require the tₘ to satisfy

t_{2N-m}=T−tₘ, m=1,2, . . . , N (1.3)

and still obtain optimum performance. In this case, the signal is fully determined by the first N values of tₙ, and we have

$$I ( t ) = {\sum }_{n = 0}^{∞} {i}_{n} sin nt , \\ \begin{matrix}{i}_{n} = \frac{2}{T} {\int }_{0}^{T} I ( t ) \cdot sin nt \cdot d t = \\ = {I}_{max} \cdot \frac{4}{nT} [ \frac{1 - {( - 1 )}^{N}}{2} + {\sum }_{m = 1}^{N - 1} {( - 1 )}^{m} cos {nt}_{m} ] ,\end{matrix} \\ n > 0 , {i}_{0} = 0. \\ \frac{\partial {i}_{n}}{\partial {t}_{m}} = {( - 1 )}^{m - 1} \cdot \frac{4 {I}_{max}}{π} \cdot sin {nt}_{m} \qquad ( 1.4 )$$

The iₙ are all real valued, and we have

$${\sum }_{1}^{∞} {i}_{n}^{2} = 2 {I}_{max}^{2} .$$

We want a selected set of the iₙ to be in prescribed ratios, iₙ_{ᵣ}=i₀ₙ_{ᵣ}, r=1,2, . . . , N, while their absolute values are as large as possible. The i₀ may not be arbitrarily chosen, since we must have

$${\sum }_{r = 1}^{N} {i}_{{n}_{r}}^{2} \leq 2 {I}_{max}^{2} \qquad ( 1.5 )$$

We therefore make the transformation

i₀ₙ_{ₖ}→K·i₀ₙ_{ₖ}, r=1,2, . . . , N, 0<K<2 (1.6)

where K is to be determined. When the i₀ are given, there is a maximum value of K beyond which there is no solution. It may be shown that a solution always exists for a sufficiently small value of K.

A suitable starting value of K may be found by trial and error. Next, starting values of tₙ are chosen. This choice is more or less arbitrary, and in particular cases, different choices may have to be tried. After calculating the iₙ, the gradient relation in (1.4) is used to find how the tₙ should be changed in order to bring the iₙ closer to their desired values. We solve the equations

$${\sum }_{m = 1}^{N} \frac{\partial {i}_{{n}_{r}}}{\partial {t}_{m}} \cdot Δ {t}_{m} = {i}_{0 {n}_{r}} - {i}_{{n}_{r}} , r = 1 , 2 , … , N \qquad ( 1.7 )$$

for the Δtₘ, and choose new values of tₘ, setting

tₘ→tₘ+α·Δtₘ (1.8)

where the constant α<1 is chosen so as to ensure convergence. This process converges quickly, or it diverges if K and/or tₙ are ill chosen. Having found a solution for the chosen value of K, we wish to make K as large as possible, while keeping the ratios of the harmonics constant. We therefore repeat the process with a larger value of K, and continue until divergence. The limiting values of K and tₘ determine an optimum signal.

### EXAMPLE

Normalising the tₘ, tₘ→tₘ/T, we set
i₀₁=0.118
i₀₂=0.259
i₀₄=1.000
K=1.000
α=0.5

We choose the initial values
t₁=0.886
t₂=1.770
t₄=2.656

Optimizing the “t”s, we get the values
t₁=1.057
t₂=1.755
t₄=2.446

The efficiency, defined as the fraction of the total power that goes into the desired harmonics, is 54%. Testing for convergence, we find that the maximum value of K is 1.187. For this value, we get
t₁=0.949
t₂=1.527
t₄=2.276

The efficiency is 76%, and the ratios of the harmonics are
i₁/i₄=0.1175
i₂/i₄=0.2599

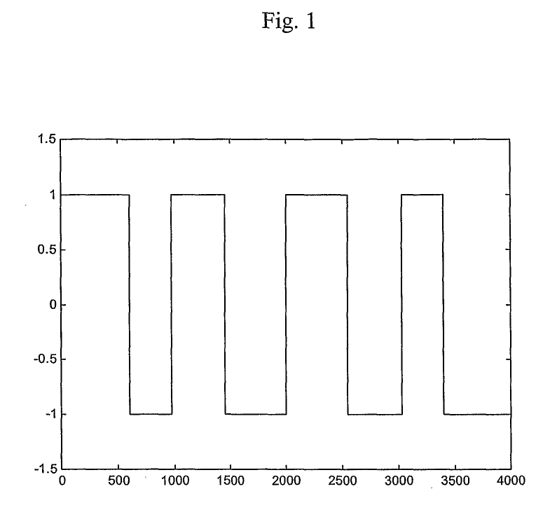

The shape of the optimum signal is shown in FIG. 1.

The optimum values of tₙ are not unique. A cyclic permutation of the “t”s does not change the shape of the signal, causing only a translation in time, but no change of the powers of the individual harmonics. Also, inversion of the sequence of “t”s has no effect on the harmonic powers. In fact, if S(t) is an optimum signal, ±S(±t+τ) is also an optimum signal for any value of τ.

1.-9. (canceled)

10. An optimized multifrequency electromagnetic signal transmitted by an antenna, the signal comprising two or more desired harmonic frequencies of optimized amplitude ratios such that substantially equal amplitude ratios of each frequency are received at a receiver, wherein when the receiver is at a maximum range a total power in the desired harmonic frequencies is a maximized proportion of the total power deliverable to the antenna.

11. The optimized multifrequency signal of claim 10, wherein an antenna current takes on values of ±I_{M} only to maximize the total power delivered to the antenna to result in a longer signal range.

12. The optimized multifrequency signal of claim 10, wherein the two or more desired harmonic frequencies are all harmonics of one frequency and the signal is periodic in time with a period of the fundamental to simplify signal synthesis.

13. The optimized multifrequency signal of claim 10, wherein the antenna is capable of radiating a circularly polarized rotating field and the desired harmonic frequencies are all odd harmonics to ensure that a polarization of each desired harmonic frequency rotates.

14. The optimized multifrequency signal of claim 10, further comprising at least a third desired harmonic frequency of optimized amplitude ratios.

15. The optimized multifrequency signal of claim 10, wherein the signal is used for the purpose of obtaining data by sea bed logging in order to determine a presence or a nature of a reservoir containing hydrocarbons or water.

16. A method of producing an optimized multifrequency electromagnetic signal, the method comprising the steps of obtaining optimized signal generating parameters using a transmitter-receiver offset length and modeled signal behavior to determine a set of desired harmonic frequencies optimally suited for logging at a site and suitable amplitude ratios for the desired harmonic frequencies; and using a transmitter to produce a signal according to the optimized signal generating parameters.

17. The method of claim 16, further comprising the step of modeling the site to be investigated through sea bed logging using known site parameters as information and combining the information with the transmitter-receiver offset length and modeled signal behavior to determine a set of desired signal frequencies optimally suited for logging at a site and suitable amplitude ratios for the desired harmonic frequencies.

18. The method of claim 16, further comprising the step of obtaining data and results for use in sea bed logging.

19. The method of claim 16, further comprising the step of using the optimized multifrequency electromagnetic signal for the purpose of obtaining data by sea bed logging.

20. The method of claim 19, further comprising the step of determining the nature of a reservoir containing hydrocarbons or water.

21. The method of claim 19, further comprising the step of determining the presence of a reservoir containing hydrocarbons or water.
